(19) United States
(12) Patent Application Publication
(10) Pub. No.: US 2009/0041557 A1
(43) Pub. Date: Feb. 12, 2009

(54) Hand-operated Pulling Device Hook Body Retaining Structure

(76) Inventor: Ching-Jung LIN, Xiu Shui Township (TW)

Correspondence Address: RABIN & BERDO, P.C., Suite 500, 1101 14th Street, N.W., Washington, DC, 20005, US

(21) Appl. No.: 11/834,892

(22) Filed: Aug. 7, 2007

(51) Int. Cl. F16B 45/00; B61D 45/00

(52) U.S. Cl. 410/97

(57) ABSTRACT

A hand-operated pulling device hook body retaining structure in which a magnetically attractive mount is fixed onto a pull strap near its hook body and, furthermore, the attachment of the magnetically attractive mount does not affect the pivoting capability of the hook body, and a powerful magnetic device is disposed at the inner lateral surface of the magnetically attractive mount that faces the hook body. Furthermore, the magnet permeates the inner side of the hook body and when the pull strap is hitched onto the cargo bed rail of a vehicle, the utilization of the magnet results in attraction between the hand-operated pulling device hook body retaining structure and the bed rail such that the dislodgement and falling off of the hook body does not readily occur, thereby also ensuring that the trussing of the pull strap is simply and efficiently conducted. As such, the present invention provides for exceptional industrial utility and practical value.

### BACKGROUND OF THE INVENTION

1) Field of the Invention

The invention herein relates to a hand-operated pulling device hook body retaining structure intended for the trussing of cargo by means of a manual puller, the present invention designed to maintain the hitched relationship between the hook body on a pull strap and the vehicle bed rail such that the hook body does not fall off during the cargo trussing process to thereby enhance the efficiency of the task.

2) Description of the Prior Art

When cargo is loaded onto a conventional freight vehicle, to keep the load intact and prevent the dropping of the cargo during the shipping process, in addition to the disposing of an appropriate cargo bed rail, in which the loaded cargo is spatially confined, the cargo is also often tied down appropriately to ensure the stationary stability of the load. As for the manner of their placement, such types of pull (restraining) straps, in addition to the use at their end sections of a hook body that is hitched to the cargo bed rail, also involve the use of a hand-operated pulling device to tighten the pull (restraining) straps into a holding state, thereby preventing their loosening.

In terms of trussing these types of pull (restraining) straps, the pull (restraining) straps utilize the hook body attached to one extremity for hitching onto the cargo bed rail at one side, the other extremity is next tossed over to and hitched onto the cargo bed rail at the remaining side or tied around the cargo bed rail and then flung over to the other cargo rail, after which they are drawn tight with the hand-operated pulling device such that the pull (restraining) straps firmly secure the cargo in place. Under this mode of operation, since only the hook bodies alone of the pull (restraining) straps are hitched to the cargo bed rail and because the other extremities of the pull (restraining) straps are passed over to the cargo bed rail at the opposite side and, furthermore, personnel thereafter go to the cargo bed rail at the opposite side, by which time the hook body on the former side has already fallen off the cargo bed rail, seriously affecting the efficiency of the trussing and securing task and, therefore, this procedure frequently requires two persons working together for successful completion, resulting in very large manpower and man-hour expenditures, a situation that awaits a means of solution and improvement.

### SUMMARY OF THE INVENTION

In view of existent pull straps drawn by hand-operated pulling devices and the hitched relationship of their hook bodies with cargo bed rails, in which it is difficult to achieve stable support and positioning, the inventor of the invention herein conducted research to effect improvement which, based on many years of experience and technology gained while engaged in the relevant fields, culminated in the successful innovation of the hook body retaining structure of the invention herein, the primary objective of which is to provide a structure wherein a magnetically attractive mount is fixed onto a pull strap near its hook body such that when the hook body is hitched to the cargo bed rail of a vehicle, the use of the magnetically attractive mount keeps it firmly attached to the cargo bed rail and thereby maintains the hitched relationship between the hook body and the cargo bed rail such that the hook body does not fall off during the cargo trussing process.

Another objective of the invention herein is to provide a structural arrangement design in which the fixing of the magnetically attractive mount onto the pull strap does not affect the normal hitching action of the hook body such that hitching the pull strap firmly and securely to the cargo bed rail is simple.

Yet another objective of the invention herein is to provide for, without affecting the magnetic attachment properties of the magnetically attractive mount, the capability of flexibly accommodating suitable variations in the shape of the hook body on the pull belt.

To further understand the structural arrangement, technological means, and other functions of the invention herein, the brief description of the drawings below are followed by the detailed description of the preferred embodiments.

### BRIEF DESCRIPTION OF THE DRAWINGS

FIG. 1 is an isometric drawing of the most preferred embodiment structure of the invention herein.

FIG. 2 is an exploded drawing of the most preferred embodiment structure of the invention herein.

FIG. 3 is a cross-sectional drawing of the most preferred embodiment structure of the invention herein.

FIG. 4 is a cross-sectional drawing of the most preferred embodiment structure of the invention herein, as viewed from another perspective.

FIG. 5 is an isometric drawing of an application example of the most preferred embodiment structure of the invention herein.

FIG. 6 is a cross-sectional drawing of the most preferred embodiment structure of the invention herein.

FIG. 7 is an isometric drawing of another most preferred embodiment structure of the invention herein.

FIG. 8 is a cross-sectional drawing of the other most preferred embodiment structure of the invention herein.

### DETAILED DESCRIPTION OF THE PREFERRED EMBODIMENTS

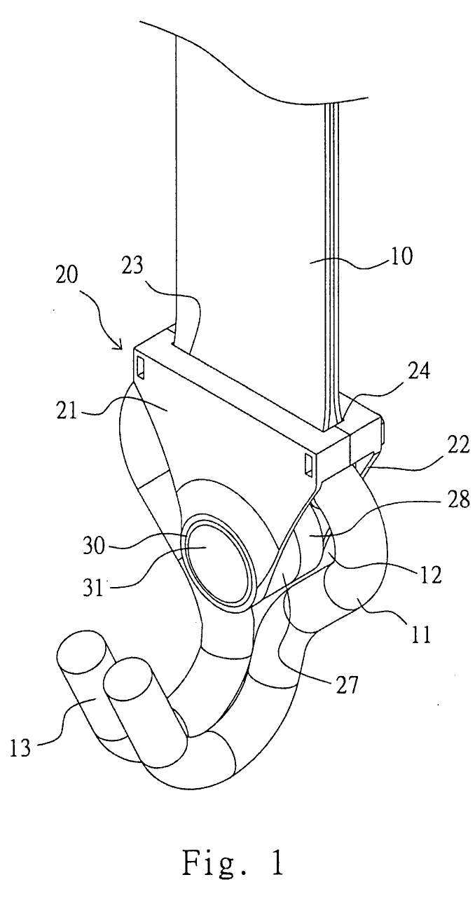

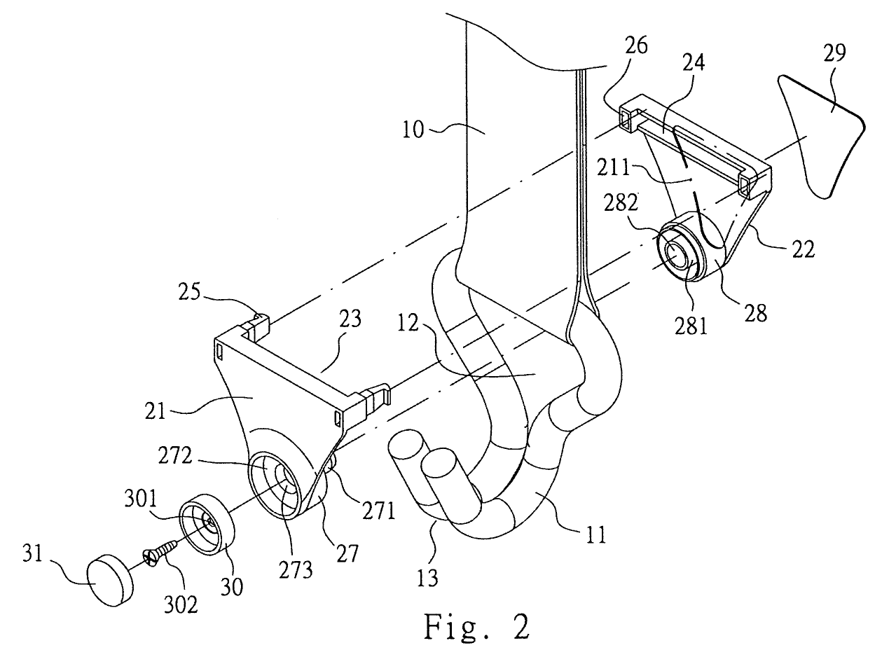

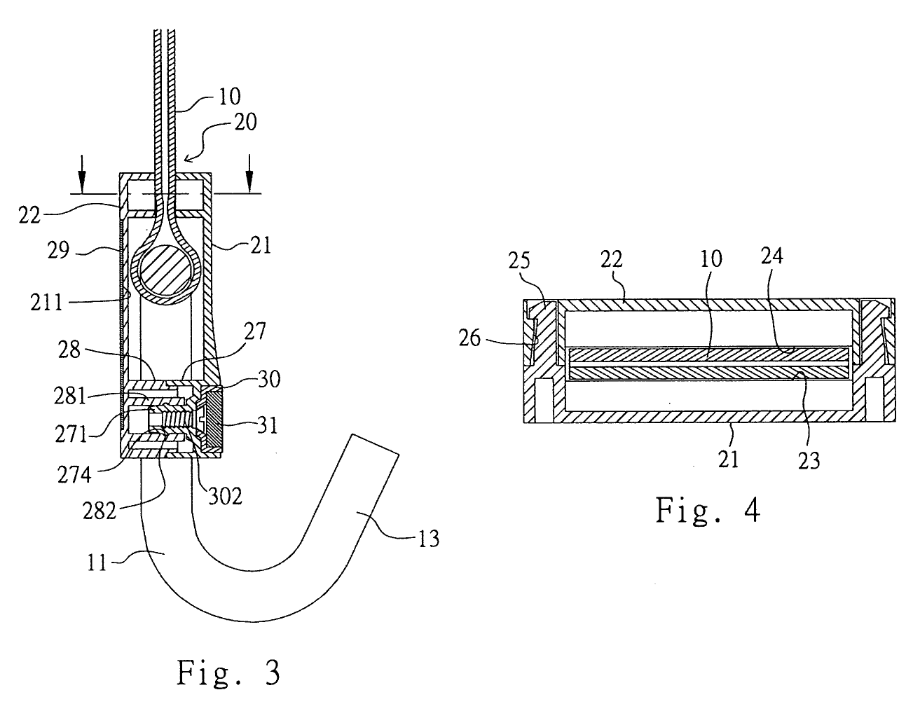

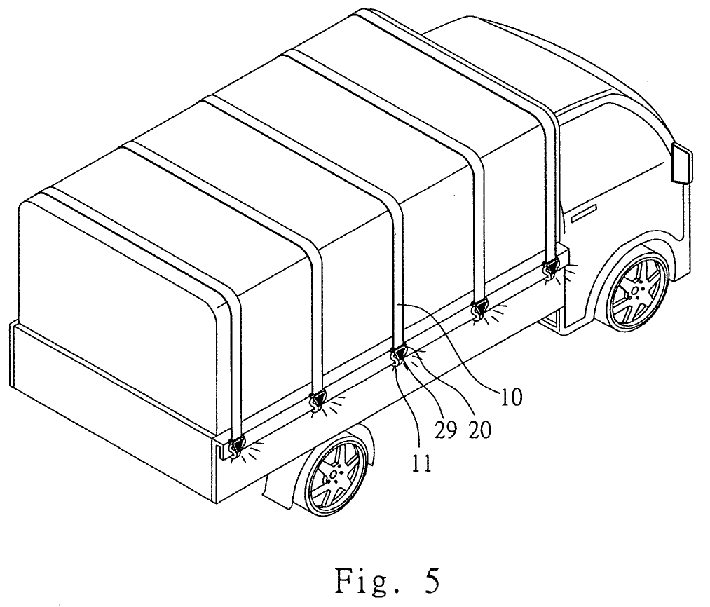

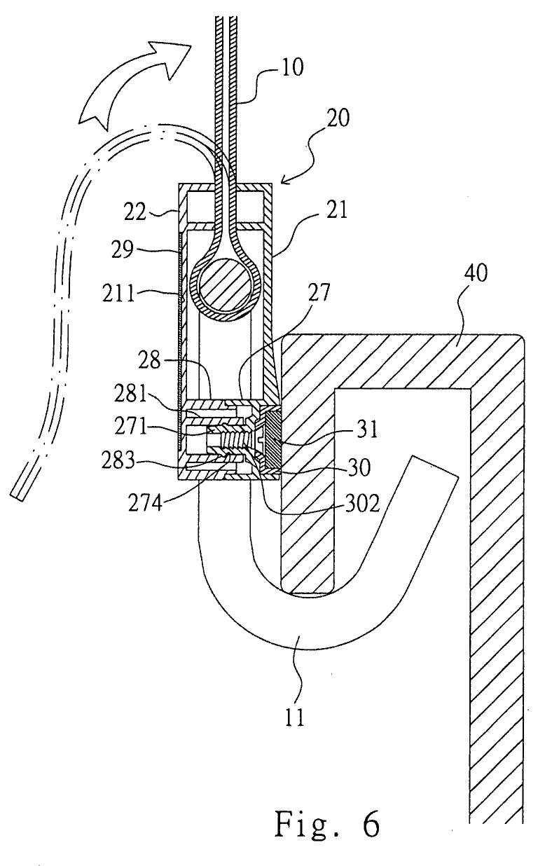

Referring to FIG. 1, FIG. 2, FIG. 3, FIG. 4, FIG. 5, and FIG. 6, as shown in said drawings of the most preferred embodiments of the present invention, the invention herein, in terms of structural design, comprises a pull strap 10 looped around and thereby fastened to a hook body 11 on which is additionally disposed a magnetically attractive mount 20, said magnetically attractive mount 20 may be of one-piece construction or, as shown in the drawings, a component consisting of an inner and an outer half 21 and 22 that are assembled together, the advantage of using the inner and the outer half 21 and 22 is their direct placement over the pull strap 10 and the avoidance thereby of a troublesome insertion task, and to facilitate the piecing together of the magnetically attractive mount 20 such that its assembly onto the pull strap 10 is effectively equivalent to an insertional procedure, in the example arrangement, the inner and outer halves 21 and 22 are fabricated as nominally triangular in shape, frame slots 23 and 24 are disposed in their facing base sections, and respectively disposed at the two ends of the frame slots 23 and 24 are corresponding mortises 26 and barbed tenons 25; and laterally disposed at the vertex angle on the respective lower ends of the inner and outer halves 21 and 22 are mutually sleeve-coupled tubular columns 27 and 28, the tubular columns 27 and 28 each having a respective post 271 and 281, wherein the post 271 of said inner half 21 consists of a threaded hole 273 formed through the center at the rear end of a recessed seat 272 prefabricated along the inner end of its tubular column 27, with an engaging protruding point 274 also disposed on the circumference at the outer extremity of said post 271; the post 281 of said outer half 22 then consisting of a channel hole 282, the inner diameter of which matches that of the outer diameter of the inner half 21 post 271, and a check groove 283 disposed at its outer extremity, and as such when the inner and outer halves 21 and 22 are assembled, the conjoinment of the tubular columns 27 and 28 on the two components occurs through an entryway 12 at the base section of the hook body 11, enabling the insertion and engagement of the inner half 21 post 271 into the outer half 22 post 281, and thereby the direct placement of the magnetically attractive mount 20 by ensleeving it onto the pull strap 10; a metal magnetic base 30 is positioned into the recessed seat 272 along the inner end of the tubular column 27 and a screw 302 is inserted into a screw hole 301 through the center of the metal magnetic base 30 to fasten and secure the assemblage; a powerful magnet 31 is then nested in the metal magnetic base 30 to constitute the magnetic means, enabling the metal magnetic base 30 and the magnet 31 to permeate the inner side of the hook body 11; and as such, when the pull strap 10 is hitched onto the metal vehicle bed rail 40 of a car body by means of the curved section 13 of the hook body 11, the magnet 31 of the magnetically attractive mount 20 conduces magnetic attachment to the vehicle bed rail 40 and, furthermore, due to the effective redoubling of magnetic force by the compound utilization of both the metal magnetic base 30 and the magnet 31, an exceptionally unyielding attraction is attained that effectively maintains the hitched relationship between the hook body 11 and the vehicle bed rail 40, such that subjection to minor external force does not lead to the occurrence of hook body 11 dislodgement, thereby also ensuring that the trussing of the pull strap 10 is simply and efficiently conducted to the extent that only a single person is required to easily complete the trussing operation; an additional aspect of the outer half 22 is an indented area 221 along its exterior surface that enables the adhesive placement of a reflective sticker 29 having the same shape, which not only enhances its appearance but also effectively serves as a reflective warning that is visible at night for increased nighttime driving safety; based on these unique capabilities, the present invention provides for exceptional industrial utility and practical value.

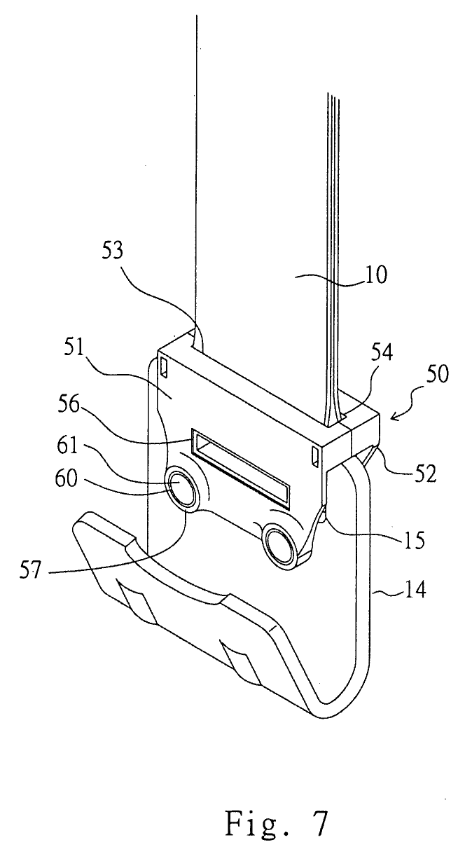

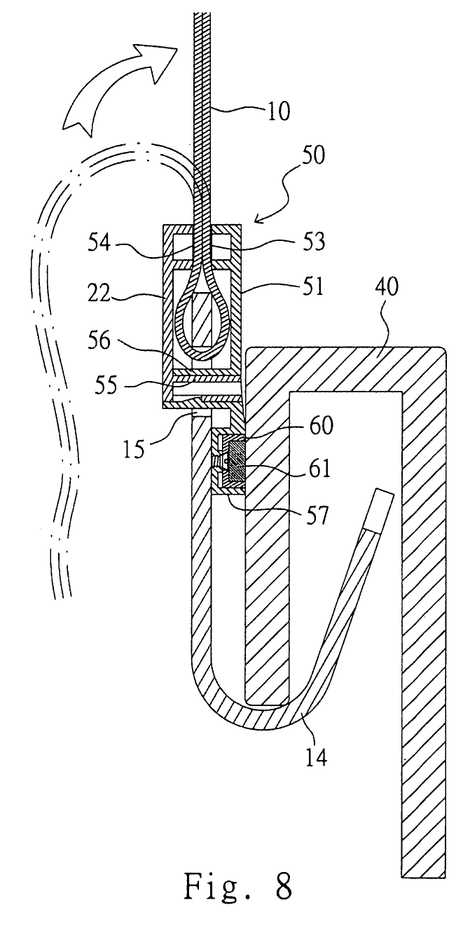

Furthermore, referring to FIG. 7 and FIG. 8, another most preferred embodiment of the invention herein, as shown in the drawings, the assembly-type magnetically attractive mount 20 of the present invention in addition to being usable with the ordinary said hook body 11 is also adaptable to a distinctive planar hook body 14 based on the assembly-type structure of said inner and outer halves 51 and 52, the inner and outer halves 51 and 52 utilize an internally long and externally short design, and at the same time, the width along their lower ends are appropriately increased, such that in addition to the frame slots 53 and 54 disposed in the facing base sections along their upper ends as well as the respective mortises (number not shown) and tenons (number not shown) constituting the insertional assembly structure, the inner and outer halves 51 and 52 also have tenons 55 and mortises 56 disposed at the entryway 15 of the planar hook body 14, enabling the magnetically attractive mount 50 to be firmly fastened onto the pull strap 10, and at the lower section interior surface of the inner half 51 is disposed a minimum of one columnar recessed seat 57 (two are shown in the drawings) in which is embedded a metal magnetic base 60 and a powerful magnet 61 (the assembly method is the same as described above), thereby enabling by means of the magnetically attractive mount 50 the similar permeation of the magnet 61 structure along the inner lateral surface of the planar hook body 14, such that when the hook body 14 is hitched to the vehicle body cargo bed rail 40, the arrangement of the other most preferred embodiment of the invention herein likewise effectively achieves magnetic attachment.

From this it may be known that the invention herein by utilizing a magnet 31 or 61 disposed in the magnetically attractive mount 20 or 50, which is fixed onto the pull strap 10 drawn by the hand-operated pulling device, achieves a positioning capability that maintains the hitched relationship between the hook body 11 or 14 of the pull strap 10 and the vehicle bed rail 40, wherein although there is no specific limitation as to the form of the magnetically attractive mount 20 or 50, the design of which may be appropriately modified according to the form of the hook body 11 or 14, the only prerequisite condition is that the magnet 31 or 61 structure must be disposed at the inner lateral surface of the magnetically attractive mount 20 or 50 that faces the hook body 11 or 14; as such, when the hook body 11 or 14 is hitched to the metal cargo bed rail 40, the combined attraction due to the utilization of the magnetically attractive mount 20 or 50 and the magnet 31 or 61 results in an expected positioning effect, thereby solving the shortcoming of existent pull straps drawn by hand-operated pulling devices, namely the bothersome loosening and dislodging of their hook bodies when they are trussed and secured, thereby providing exceptional industrial utility and practical value, and since it is of an outstanding, advanced, and innovative design, the invention herein is lawfully submitted in application for the commensurate patent rights.

What is claimed is:

1. A hand-operated pulling device hook body retaining structure that is designed to maintain the hitched relationship between a hook body fastened to the end section of a pull strap drawn by a hand-operated pulling device and a metal cargo bed rail, the unique features of which include: the pull strap drawn by the hand-operated pulling device has fixed near said hook body an additionally fabricated magnetically attractive mount and a powerful magnetic device is disposed at the inner lateral surface of said magnetically attractive mount that faces the hook body.

2. A hand-operated pulling device hook body retaining structure as claimed in claim 1, wherein said powerful magnetic device at the inner lateral surface of the magnetically attractive mount consists of a metal magnetic base and powerful magnet in a compound assembly arrangement.

3. A hand-operated pulling device hook body retaining structure as claimed in claim 1, wherein one or more said magnetic device may be disposed at the inner lateral surface of said magnetically attractive mount.

4. A hand-operated pulling device hook body retaining structure as claimed in claim 1, wherein said magnetically attractive mount may be of one-piece construction and also insertionally connected to the pull strap.

5. A hand-operated pulling device hook body retaining structure as claimed in claim 1, wherein said magnetically attractive mount is an assembly-type structure such that when the magnetically attractive mount is assembled, it is pieced together onto said pull strap.

6. A hand-operated pulling device hook body retaining structure as claimed in claim 1, wherein said magnetic device at the inner lateral surface of the magnetically attractive mount consists of a columnar recessed seat prefabricated at the interior surface of its said magnetically attractive mount and a post disposed at the center of said recessed seat, and after the metal magnetic base is positioned into said recessed seat and fastened and secured by a screw, the powerful magnet is then nested in said metal magnetic base to complete assembly.

7. A hand-operated pulling device hook body retaining structure as claimed in claim 1, wherein said magnetically attractive mount has an indented area along its exterior surface that enables the adhesive placement of a reflective sticker.

8. A hand-operated pulling device hook body retaining structure as claimed in claim 1, wherein said magnetically attractive mount consists of an inner and an outer half that are assembled together, frame slots are disposed in the facing base sections of said inner and outer halves, respectively disposed at the two ends of the frame slots are corresponding mortises and barbed tenons that enable the direct placement of the magnetically attractive mount onto said pull strap, at the lower section interior surface of the magnetically attractive mount is disposed the columnar recessed seat in which is embedded a metal magnetic base and, furthermore, a powerful magnet is nested in the recessed seat to constitute the magnetic means.
